(19) United States
(12) Patent Application Publication
(10) Pub. No.: US 2016/0087249 A1
(43) Pub. Date: Mar. 24, 2016

(54) THIN BATTERY

(71) Applicant: PANASONIC INTELLECTUAL PROPERTY MANAGEMENT CO., LTD., Osaka (JP)

(72) Inventors: Yuya ASANO, Osaka (JP); Tomohiro UEDA, Osaka (JP)

(73) Assignee: PANASONIC INTELLECTUAL PROPERTY MAMAGEMENT CO., LTD., Osaka (JP)

(21) Appl. No.: 14/786,937

(22) PCT Filed: May 27, 2014
(86) PCT No.: PCT/JP2014/002774

§ 371 Date: Oct. 23, 2015

(30) Foreign Application Priority Data
May 31, 2013 (JP) 2013-114989

(51) Int. Cl. H01M 2/02; H01M 6/18; H01M 2/30

(52) U.S. Cl. CPC H01M 2/021; H01M 2/0212; H01M 2/30; H01M 6/181; H01M 2300/0082; H01M 2220/30

(57) ABSTRACT

Provided is a thin battery including: a sheet-like electrode assembly including a positive electrode, a negative electrode, and an electrolyte layer interposed therebetween; electrode lead terminals connected to the positive electrode and the negative electrode, respectively; and an outer packaging housing the electrode assembly, each one of the positive and negative electrodes including a current collector and an active material layer, the current collector having a main portion and an extending portion, the main portion having a formed portion with the active material layer and a non-formed portion without the active material layer, the extending portion extending from a part of the non-formed portion, a first end portion of each of the electrode lead terminals having a joining portion joined to the non-formed portion and the extending portion, and a second end portion of each of the electrode lead terminals extended out of the outer packaging.

### TECHNICAL FIELD

The present invention relates to a thin battery, particularly to a thin battery with improved durability against bending deformation.

### BACKGROUND ART

In recent years, with digitalization of information, various electronic devices, such as electronic papers, IC tags, multifunctional cards, and electronic keys, are in widespread use; and there has been a demand for such electronic devices to be made thinner. Known as power sources installed in thin electronic devices are, for example, thin batteries comprising an outer packaging formed of a laminate film and an electrode assembly housed therein. In most instances, such thin batteries are produced with use of an electrode assembly in sheet form. This is because batteries become thick when an electrode assembly comprising a positive electrode and a negative electrode wound with a separator interposed therebetween is used.

Regarding thin batteries, for example, a proposal has been made for those produced by placing an electrode assembly in an outer packaging and then sealing it therein, the electrode assembly produced by stacking a positive electrode including a positive electrode current collector and a positive electrode active material layer formed thereon and a negative electrode including a negative electrode current collector and a negative electrode active material layer formed thereon, with a separator interposed therebetween, and then joining an electrode lead terminal to each of the current collectors. Furthermore, a proposal has been made for thin batteries having an energy density that is improved by disposing the respective joining portions between the current collectors and the corresponding electrode lead terminals to at least partially overlap the sealing portion of the outer packaging (e.g., see Patent Literature 1).

### PRIOR ART

### Patent Literature

[Patent Literature 1] Japanese Laid-Open Patent Publication No. 2010-114041

### SUMMARY OF INVENTION

### Technical Problem

A conventional typical thin battery is illustrated in FIGS. 6A to 6C. FIG. 6A is an oblique external view schematically depicting a thin battery 101; FIG. 6B is an oblique exploded view of an electrode assembly 111 housed in an outer packaging 112; and FIG. 6C is a top view of the electrode assembly 111.

A positive electrode 102 in the thin battery includes: a positive electrode current collector 104 with a positive electrode active material layer 105 formed on the surface thereof; and a positive electrode extending portion 104a extending from a part of the positive electrode current collector 104. Note that the positive electrode active material layer 105 is not formed on the surface of the positive electrode extending portion 104a. A positive electrode lead terminal 106 is disposed such that an end portion 106e thereof is positioned on the surface of the positive electrode extending portion 104a, and is joined to the positive electrode extending portion 104a. Likewise, a negative electrode 103 includes: a negative electrode current collector 107 with a negative electrode active material layer 108 formed on the surface thereof; and a negative electrode extending portion 107a extending from a part of the negative electrode current collector 107. Note that the negative electrode active material layer is not formed on the surface of the negative electrode extending portion 107a. A negative electrode lead terminal 109 is disposed such that an end portion 109e thereof is positioned on the surface of the negative electrode extending portion 107a, and is joined to the negative electrode extending portion 107a.

The positive electrode 102 and the negative electrode 103 are stacked with an electrolyte layer 110 interposed therebetween, such that the positive electrode active material layer 105 and the negative electrode active material layer 108 face each other, and as such, the electrode assembly 111 as illustrated in FIG. 6C is formed. The electrode assembly 111 is sealed in the outer packaging 112, such that the respective other end portions of the positive electrode lead terminal 106 and the negative electrode lead terminal 109 (hereafter, these may be collectively referred to as electrode lead terminal) are extended out of the outer packaging 112. As such, the thin battery 101 as in FIGS. 6A to 6C is formed.

Thin batteries are installed in thin electronic devices. In accordance with wider varieties of purposes and manners of use, electronic devices have been gradually made thinner and smaller, and are also required to be flexible. Since thin batteries serve as power sources for such electronic devices, they are required not to lose reliability as batteries, even when the electronic devices become deformed due to bending. However, repeated bending deformation may cause failure of connection between the electrode assembly and the electrode lead terminal.

The present invention is in view of the above problem, and mainly aims to provide a highly-reliable thin battery with excellent durability against repeated bending deformation.

### Solution to Problem

That is, the present invention relates to a thin battery including: an electrode assembly in sheet form including a positive electrode, a negative electrode, and an electrolyte layer interposed therebetween; a pair of electrode lead terminals, the terminals connected to the positive electrode and the negative electrode, respectively; and an outer packaging housing the electrode assembly, each one of the positive electrode and the negative electrode including a current collector and an active material layer, the current collector having a main portion and an extending portion extending from a part of the main portion, the main portion having a formed portion on which the active material layer is formed and a non-formed portion on which the active material layer is not formed, the extending portion extending from a part of the non-formed portion, a first end portion of each of the electrode lead terminals having a joining portion joined to the non-formed portion and the extending portion, and a second end portion of each of the electrode lead terminals extended out of the outer packaging.

### Advantageous Effect of Invention

According to the present invention, a highly-reliable thin battery can be obtained because of improvement in durability against repeated bending deformation.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1A is an oblique external view of a thin battery according to one embodiment of the present invention.

FIG. 1B is an oblique external view of a positive electrode for the thin battery illustrated in FIG. 1A.

FIG. 1C is an oblique external view of a negative electrode for the thin battery illustrated in FIG. 1A.

FIG. 1D is an oblique exploded view of an electrode assembly for the thin battery illustrated in FIG. 1A.

FIG. 1E is a top view of the electrode assembly for the thin battery illustrated in FIG. 1A.

FIG. 2A is a top view depicting a current collector and an electrode lead terminal joined to the current collector, for the thin battery according to the one embodiment of the present invention.

FIG. 2B is a top view depicting a current collector and an electrode lead terminal joined to the current collector, for a thin battery according to another embodiment of the present invention.

FIG. 2C is a top view depicting a current collector and an electrode lead terminal joined to the current collector, for a thin battery according to still another embodiment of the present invention.

FIG. 3A is an oblique external view of a positive electrode for the thin battery according to the another embodiment of the present invention.

FIG. 3B is an oblique external view of a positive electrode for the thin battery according to the still another embodiment of the present invention.

FIG. 4 is an oblique exploded view of an electrode assembly for the thin battery according to the another embodiment of the present invention.

FIG. 5 is an explanatory illustration depicting the bending resistance test method.

FIG. 6A is an oblique external view of a thin battery according to conventional technique.

FIG. 6B is an oblique exploded view of an electrode assembly for the thin battery illustrated in FIG. 6A.

FIG. 6C is a top view of the electrode assembly for the thin battery illustrated in FIG. 6A.

### DESCRIPTION OF EMBODIMENTS

The present invention relates to a thin battery including: an electrode assembly in sheet form including a positive electrode, a negative electrode, and an electrolyte layer interposed between the positive electrode and the negative electrode; a pair of electrode lead terminals, the terminals connected to the positive electrode and the negative electrode, respectively; and an outer packaging housing the electrode assembly, each one of the positive electrode and the negative electrode including a current collector and an active material layer, the current collector having a main portion and an extending portion extending from a part of the main portion, the main portion having a formed portion on which the active material layer is formed and a non-formed portion on which the active material layer is not formed, the extending portion extending from a part of the non-formed portion, a first end portion of each of the electrode lead terminals having a joining portion joined to the non-formed portion and the extending portion, and a second end portion of each of the electrode lead terminals extended out of the outer packaging.

Even when the thin battery is subjected to bending deformation and a bending load is repeatedly applied to the current collector, according to the structure of the present invention, cracking and breakage of the current collector are suppressed, and a highly-reliable thin battery is obtained.

The first end portion and the formed portion are preferably not in contact with each other. This further reduces concentration of the bending load on an endmost portion of the first end portion (hereafter, simply referred to as endmost portion).

A length B of a minimal-length line L connecting the first end portion and the formed portion, and a maximum width A of the non-formed portion parallel to the minimal-length line L, preferably satisfy the relation of 0.25≦B/A≦0.75. When B/A≦0.75, the joining strength between the electrode lead terminal and the non-formed portion further increases. When 0.25≦B/A, concentration of the bending load on the endmost portion is further reduced, and the effect of suppressing cracking and breakage of the current collector improves.

A ratio of a thickness C of the electrode lead terminal to a thickness D of the current collector to which the electrode lead terminal is joined: C/D, is preferably 6.25 or less. Since the difference between the thickness of the electrode lead terminal and the thickness of the current collector to which the electrode lead terminal is joined becomes small, concentration of the bending load on the endmost portion is reduced, and the effect of suppressing cracking and breakage further improves.

For at least one of the positive electrode and the negative electrode, two or more electrodes are preferably stacked. This allows increase in the apparent thicknesses of the current collectors in the vicinity of the endmost portions, thereby reducing concentration of the bending load on the endmost portions, and the effect of suppressing cracking and breakage further improves. Moreover, by increasing the number of the electrodes stacked, the energy density of the battery also improves.

The reason for occurrences of cracks and breaks in the current collector due to the bending load, is presumed to be as follows.

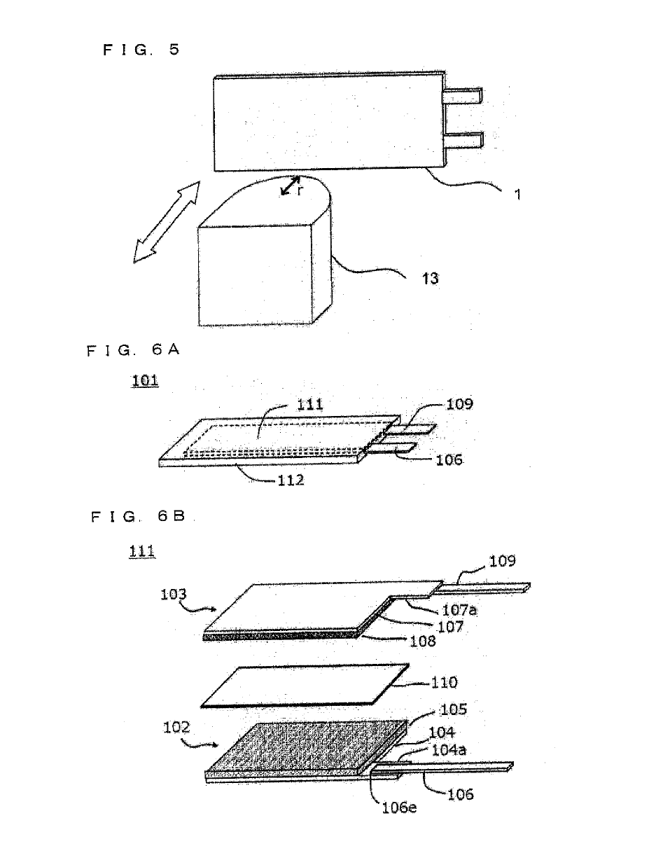

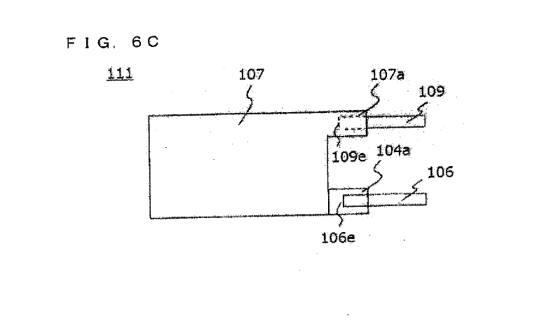

As illustrated in FIG. 6B, a positive electrode lead terminal 106 largely differing from an extending portion 104a in thickness, is joined to the extending portion 104a by welding or the like, at a part where the two overlap each other. When a thin battery 101 is repeatedly subjected to bending deformation, the bending load concentrates on a part having relatively low rigidity; and particularly when materials differing in rigidity are joined, the bending load concentrates on a position of the one with lower rigidity where an endmost portion of the one with higher rigidity is disposed. Since thicknesses of metal foils or the like used for the current collector and the electrode lead terminal are very small, rigidities of the current collector and the electrode lead terminal greatly depend on those thicknesses. Therefore, regarding the thin battery, the bending load concentrates on a position of the positive electrode extending portion 104a of the current collector with smaller thickness (lower rigidity), where an endmost portion 106e of the positive electrode lead terminal 106 with greater thickness (higher rigidity) is disposed. Therefore, cracks due to the bending load tend to easily occur in the positive electrode extending portion 104a at the position corresponding to the endmost portion 106e, and in some instances, such cracks lead to breakage. When the endmost portion 106e is in close proximity to the point where the positive electrode extending portion 104a starts to extend, cracks are more likely to occur. When cracks occur in the extending portion, it becomes difficult to secure a connection between the positive electrode lead terminal joined thereto and the electrode assembly, resulting in lower reliability. This likewise applies to the negative electrode 103.

Therefore, the present invention is to provide a way to suppress concentration of the bending load on the extending portion, without significantly changing the shape and thinness of the thin battery.

The embodiments of the present invention will now be described in detail, with use of drawings. Note that the following embodiments are merely examples embodying the present invention, and are not to be construed as limiting in any way the technical scope of the present invention.

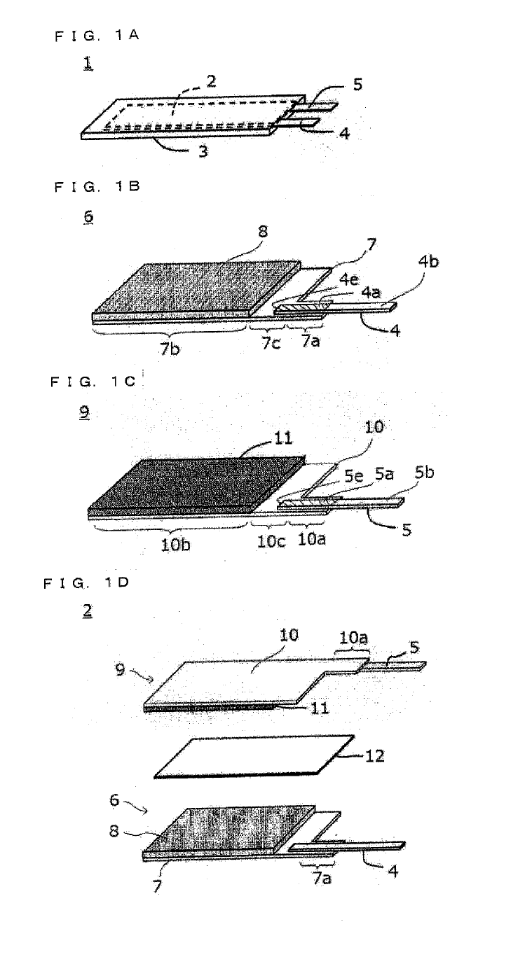

As illustrated in FIG. 1A, a thin battery 1 according to the present embodiment includes an electrode assembly 2, an outer packaging 3 housing the electrode assembly 2 therein, and a positive electrode lead terminal 4 and a negative electrode lead terminal 5 which lead current to the outside.

As illustrated in FIG. 1D, the electrode assembly 2 includes a positive electrode 6 and a negative electrode 9 that are disposed with an electrolyte layer 12 interposed therebetween, such that a positive electrode active material layer 8 and a negative electrode active material layer 11 face each other. FIG. 1E depicts a top view of the electrode assembly 2. The electrode assembly 2 is housed in the outer packaging 3, such that respective second end portions (4b and 5b) of the positive electrode lead terminal 4 and the negative electrode lead terminal 5 are extended out of the outer packaging 3.

The positive electrode 6 includes a positive electrode current collector 7 and the positive electrode active material layer 8, and the positive electrode lead terminal 4 is joined to the positive electrode current collector 7. The positive electrode current collector 7 has a main portion and an extending portion 7a extending from a part of the main portion. Moreover, the main portion has a formed portion 7b on which the positive electrode active material layer 8 is formed and a non-formed portion 7c on which the positive electrode active material layer 8 is not formed; and the extending portion 7a extends from a part of the non-formed portion 7c. The positive electrode 6 can have a structure as illustrated in FIG. 1B, for example.

A first end portion 4a of the positive electrode lead terminal 4 is disposed astride the non-formed portion 7c and the extending portion 7a. In other words, the first end portion 4a is a part of the positive electrode lead terminal 4 which overlaps the non-formed portion 7c and the extending portion 7a. The first end portion 4a has a joining portion joined to the non-formed portion 7c and the extending portion 7a. That is, the first end portion 4a is joined to the positive electrode current collector 7, at both of the non-formed portion 7c and the extending portion 7a. Note that the first end portion 4a may be mostly (e.g., 90% or more of the overlapping area) joined to the current collector 7, or may be partially joined thereto by spot welding or the like.

In the present embodiment, an endmost portion 4e is positioned on the non-formed portion 7c. As described above, the bending load concentrates on a position on the positive electrode current collector 7, corresponding to the endmost portion 4e. However, according to the present embodiment, since the position on the current collector 7 corresponding to the endmost portion 4e is on the non-formed portion 7c, the bending load is dispersed entirely over the non-formed portion 7c. The non-formed portion 7c has a sufficiently wider region than the extending portion 7a, and also has a greater width than the extending portion 7a. Therefore, cracking and breakage of the current collector can be suppressed. As a result, a connection between the electrode lead terminal and the electrode assembly is secured, and reliability of the battery improves. This likewise applies to the negative electrode 9 described below.

As with the positive electrode 6, the negative electrode 9 also includes a negative electrode current collector 10 and the negative electrode active material layer 11, and the negative electrode lead terminal 5 is joined to the negative electrode current collector 10. The negative electrode current collector 10 has a main portion and an extending portion 10a extending from a part of the main portion. Moreover, the main portion has a formed portion 10b on which the negative electrode active material layer 11 is formed and a non-formed portion 10c on which the negative electrode active material layer 11 is not formed; and the extending portion 10a extends from a part of the non-formed portion 10c. The negative electrode lead terminal 5 is disposed astride the non-formed portion 10c and the extending portion 10a; and a first end portion 5a of the negative electrode lead terminal 5 has a joining portion joined to the non-formed portion 10c and the extending portion 10a. An endmost portion 5e is positioned on the non-formed portion 10c. The negative electrode 9 can have a structure as illustrated in FIG. 1C, for example.

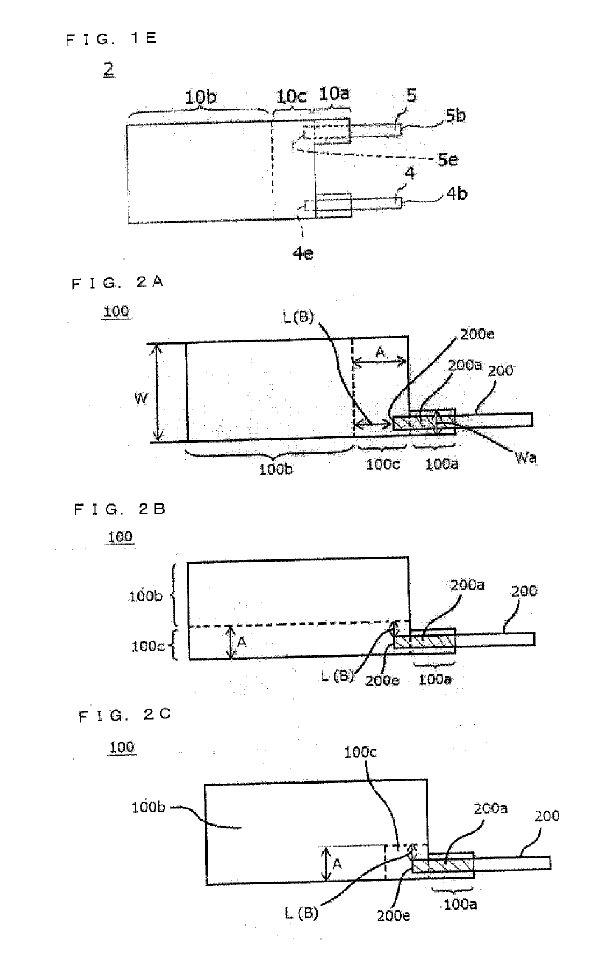

With reference to FIGS. 2A to 2C, a description will now be given of common structures shared between the positive electrode 6 and the negative electrode 9, such as the positive electrode lead terminal 4 and the negative electrode lead terminal 5 (hereafter, these will be collectively referred to as electrode lead terminal 200) and the positive electrode current collector 7 and the negative electrode current collector 10 (hereafter, these will be collectively referred to as current collector 100).

FIGS. 2A to 2C illustrate the current collector 100 and the electrode lead terminal 200 joined to the current collector 100. The current collector 100 has a main portion and an extending portion 100a. The main portion has a formed portion 100b on which an active material layer (not illustrated) is formed and a non-formed portion 100c on which the active material layer is not formed; and the extending portion 100a extends from a part of the non-formed portion 100c. The electrode lead terminal 200 is disposed astride the non-formed portion 100c and the extending portion 100a; and a first end portion 200a of the electrode lead terminal 200 has a joining portion joined to the non-formed portion 100c and the extending portion 100a. An endmost portion 200e of the first end portion 200a is positioned on the non-formed portion 100c.

The disposition of the electrode lead terminal 200 is not particularly limited, if disposed astride the non-formed portion 100c and the extending portion 100a. Particularly, there is preferably no contact between the first end portion 200a and the formed portion 100b. That is, the non-formed portion 100c is preferably interposed between the first end portion 200a and the formed portion 100b. By the above, the bending load does not concentrate on a position on the current collector 100 corresponding to the endmost portion 200e, and instead, is dispersed to the non-formed portion 100c; and the effect of suppressing cracking and breakage of the current collector 100 improves.

Moreover, a length B of a minimal-length line L connecting the first end portion 200a and the formed portion 100b, and a maximum width A of the non-formed portion 100c parallel to the minimal-length line L, preferably satisfy the relation of 0.25≦B/A≦0.75 (see FIGS. 2A to 2C). B/A is further preferably 0.3 or more, and also, further preferably 0.7 or less. The length B is a length from the endmost portion 200e to the formed portion 100b in FIG. 2A.

When B/A falls within the above range, the joining area between the electrode lead terminal 200 and the non-formed portion 100c can be made sufficiently wide, and the joining strength can be increased. Also, the non-formed portion 100c having a sufficient region can be interposed between the first end portion 200a and the formed portion 100b. Since rigidity of the non-formed portion 100c tends to become relatively low compared to the formed portion 100b, the load produced when the battery is subjected to bending deformation tends to easily concentrate on the non-formed portion 100c. However, by increasing the region of the non-formed portion 100c present between the first end portion 200a and the formed portion 100b, concentration of the load is reduced and the effect of suppressing cracking and breakage improves.

An area S of the part where the first end portion 200a and the non-formed portion 100c overlap with each other is preferably 1 to 20% relative to the area of the non-formed portion 100c. When the proportion of the area S falls within this range, the joining strength as well as the effect of suppressing cracking and breakage further improves.

The extending portion 100a extends from a part of the non-formed portion 100c. The extending portion 100a is provided in order to join the electrode lead terminal 200 to the current collector 100. Therefore, the width of the extending portion 100a only has to be greater than the width of the electrode lead terminal 200, and typically, a width Wa of the extending portion 100a is sufficiently smaller than a width W of one side of the current collector 100 from which the extending portion 100a extends (see FIG. 2A). On the other hand, in order to suppress cracking and breakage of the current collector 100, the width Wa of the extending portion 100a is preferably wide than narrow. Particularly, in view of cost, suppression of a short circuit between the positive and negative electrodes, and other factors, the width Wa of the extending portion 100a is preferably 8 to 45% and further preferably 8 to 30% of the width W of the side of the current collector 100 from which the extending portion 100a extends. According to the present embodiment, even when the width of the extending portion 100a is narrow, cracking and breakage of the current collector 100 can be suppressed.

Moreover, a ratio of a thickness C of the electrode lead terminal 200 to a thickness D of the current collector 100 to which the electrode lead terminal 200 is joined: C/D, is preferably 6.25 or less. By the smaller difference in thickness between the electrode lead terminal 200 and the current collector 100 to which the terminal 200 is joined, concentration of the bending load on the current collector 100 at a position corresponding to the endmost portion 200e is reduced, and the effect of suppressing cracking and breakage further improves. The ratio C/D is preferably 1 or more and further preferably 3.0 or more.

Note that either one of the positive electrode or the negative electrode may satisfy the above relation. It is further preferable that both of the positive electrode and the negative electrode satisfy the above relation.

The electrolyte layer 12 is interposed between the positive electrode 6 and the negative electrode 9. The electrolyte layer 12 is in sheet form, for example; and preferably has a size larger than or equal to the size of each of the main portions, so that the positive electrode and the negative electrode do not come in contact. For example, the electrolyte layer 12 has an area corresponding to 100% or more and preferably 110% or more of each of the main portions.

In FIG. 1D, the positive electrode lead terminal 6 is joined to the side of the positive electrode current collector 7 with the positive electrode active material layer 8 formed thereon; however, the lead terminal 6 may be joined to the side thereof without the positive electrode active material layer 8 formed thereon. This likewise applies to the negative electrode lead terminal 5. Moreover, in FIG. 1D, the positive electrode active material layer 8 is formed only on one surface of the positive electrode current collector 7; however, the active material layer 8 may be formed on both surfaces thereof. This likewise applies to the negative electrode active material layer 11.

In FIGS. 1B, 1C, and other drawings, the respective main portions of the positive electrode current collector and the negative electrode current collector are illustrated as being rectangular; however, the shapes of the respective main portions are not limited to a rectangle. Particularly, in view of productivity, the respective main portions are preferably rectangular.

Moreover, in FIG. 1C, on the rectangular main portion, the non-formed portion 7c extends along the entire length of one side of the positive electrode current collector 7 having the extending portion 7a; however, as illustrated in FIG. 3B, the non-formed portion 7c may extend along the entire length of another side thereof, or, as illustrated in FIG. 3A, may be formed to be along only a part of the side thereof having the extending portion 7a. Alternatively, the non-formed portion 7c may be formed as a triangle including the side thereof having the extending portion 7a. Among the above, in view of productivity, the non-formed portion 7c preferably extends along the entire length of the side of the positive electrode current collector 7 having the extending portion 7a, as a rectangle (see FIG. 1C); and in view of electrical capacity, the non-formed portion 7c is preferably formed to have a relatively small area. This likewise applies to the non-formed portion 10c of the negative electrode current collector 10.

The shapes of the extending portions 7a and 10a are also not particularly limited. Examples include a rectangle (strip form), a shape with rounded corners, and a semicircle. Among these, in terms of productivity, a rectangle (strip form) is preferred.

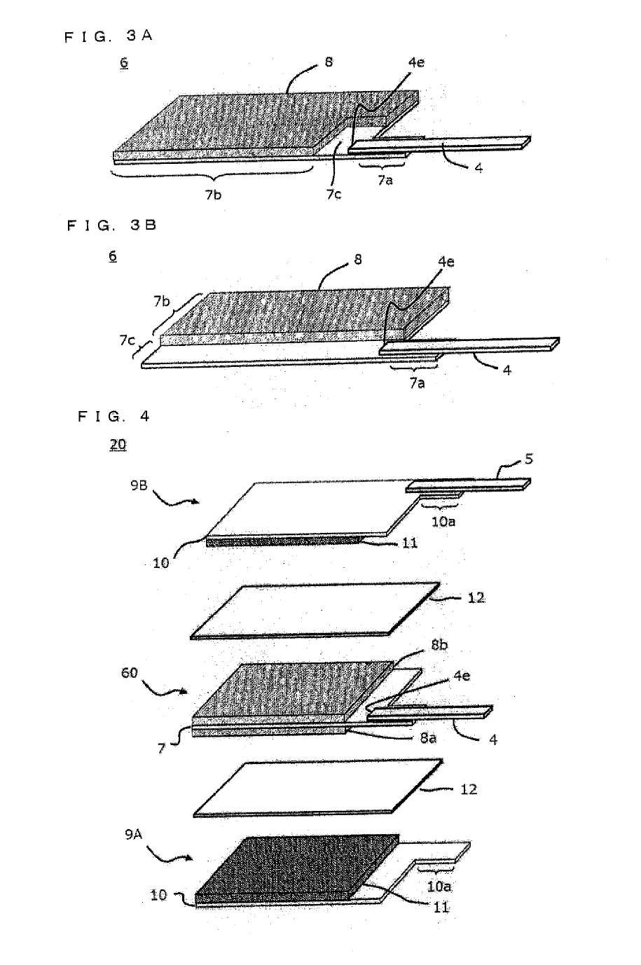

In the present embodiment, a pair of the positive electrode and the negative electrode is the smallest structural unit in the electrode assembly. For at least one of the positive electrode and the negative electrode, two or more electrodes may be stacked (see FIG. 4). This is because rigidity in the vicinity of the endmost portions increases and concentration of the bending load can be further reduced. Furthermore, the energy density of the battery can be improved. In such instance, the positive electrodes stacked are electrically connected to one another by joining their respective extending portions together. This likewise applies to the negative electrode.

In FIG. 4, a negative electrode 9B polarized differently from a positive electrode 60 is stacked on the surface of the positive electrode 60 on the side opposite of a negative electrode 9A, thereby to form an electrode assembly. Regarding the positive electrode 60, positive electrode active material layers (8a and 8b) are formed on the surfaces of a positive electrode current collector 7, respectively. The two negative electrodes 9A and 9B are positioned to sandwich the positive electrode 60; and on one surface of each of negative electrode current collectors 10, a negative electrode active material layer 11 is formed. Electrolyte layers 12 are interposed between the negative electrode 9A and the positive electrode 60 and between the positive electrode 60 and the negative electrode 9B, respectively. An extending portion 10a in the negative electrode 9A is joined to an extending portion 10a in the negative electrode 9B. Moreover, a negative electrode lead terminal 5 is joined to the negative electrode current collector 10 of either one of the negative electrode 9A or the negative electrode 9B. An endmost portion 4e of a positive electrode lead terminal 4 is sandwiched between the two electrolyte layers and the two negative electrode current collectors 10, and therefore has a greater apparent thickness and higher rigidity. Thus, concentration of the bending load is further reduced.

When the number of the positive electrodes and/or the negative electrodes stacked becomes too large, the thickness of the thin battery increases and the advantages of the thin battery lessen. Thus, the total number of the positive electrodes and negative electrodes stacked is preferably 15 or less and further preferably 10 or less. Moreover, the thickness of the electrode assembly is preferably about 0.3 to 1.5 mm and further preferably about 0.5 to 1.5 mm. Note that not every one of the electrodes forming the electrode assembly needs to satisfy the present embodiment. As long as the positive electrode and the negative electrode to which the electrode lead terminals are joined, respectively, satisfy the present embodiment, the effect of the present invention will be delivered.

A description will now be given of a detailed structure of the thin battery according to the present embodiment.

### (Positive Electrode)

The positive electrode includes the positive electrode current collector and the positive electrode active material layer; and the positive electrode active material layer is formed on a part of the positive electrode current collector. Examples of the positive electrode current collector include metal materials, such as a metal film, a metal foil, and a non-woven fabric of metal fibers. Examples of the kind of metal used include silver, nickel, titanium, gold, platinum, aluminum, and stainless steel. These metals may be used singly or in a combination of two or more. The thickness of the positive electrode current collector is preferably 5 to 30 μm and further preferably 8 to 15 μm.

The positive electrode active material layer may be a material mixture layer including a positive electrode active material and as necessary, a binder and/or a conductive agent. The positive electrode active material is not particularly limited. When the thin battery is a primary battery, examples of the positive electrode active material include manganese dioxide, carbon fluorides, a metal sulfide, a lithium-containing composite oxide, a vanadium oxide, a lithium-containing vanadium oxide, a niobium oxide, a lithium-containing niobium oxide, a conjugated polymer containing a conductive organic material, a Chevrel phase compound, and an olivine-type compound. Among these, manganese dioxide, carbon fluorides, a metal sulfide, and a lithium-containing composite oxide are preferred; and manganese dioxide is particularly preferred.

Examples of carbon fluorides include fluorinated graphite represented by (CF_{w})ₘ, (where: m is an integer of 1 or higher; and 0<w≦1). Examples of a metal sulfide include TiS₂, MoS₂, and FeS₂.

When the thin battery is a secondary battery, examples of the positive electrode active material include a lithium-containing composite oxide, such as LiₓₐCoO₂, LiₓₐNiO₂, LiₓₐMnO₂, LiₓₐCo_{y}Ni_{1-y}O₂, LiₓₐCo_{y}M_{1-y}O_{z}, LiₓₐNi_{1-y}M_{y}O_{z}, Li_{xb}Mn₂O₄, and Li_{xb}Mn_{2-y}M_{y}O₄. Here, M is at least one element selected from the group consisting of Na, Mg, Sc, Y, Mn, Fe, Co, Ni, Cu, Zn, Al, Cr, Pb, Sb, and B; and xa=0 to 1.2, xb=0 to 2, y=0 to 0.9, and z=2 to 2.3. The variables xa and xb increase and decrease by charge and discharge.

Examples of the conductive agent include: graphites, such as natural graphite and artificial graphite; and carbon blacks, such as acetylene black, Ketjen black, channel black, furnace black, lamp black, and thermal black. The amount of the conductive agent is, for example, 0 to 20 parts by mass per 100 parts by mass of the positive electrode active material.

Examples of the binder include: a fluorocarbon resin having vinylidene fluoride units, such as polyvinylidene fluoride (PVdF); a fluorocarbon resin not having vinylidene fluoride units, such as polytetrafluoroethylene; an acrylic resin, such as polyacrylonitrile and polyacrylic acid; and rubbers, such as styrene-butadiene rubber. The amount of the binder is, for example, 0.5 to 15 parts by mass per 100 parts by mass of the positive electrode active material.

The thickness of the positive electrode active material layer is, for example, preferably 1 to 300 μm. When the thickness thereof is 1 μm or more, sufficient capacity can be maintained; whereas when the thickness thereof is 300 μm or less, the flexibility of the positive electrode increases and the bending load to the current collector tends to be easily reduced.

### (Positive Electrode Lead Terminal)

The material for the positive electrode lead terminal is not particularly limited if electrochemically and chemically stable and with conductivity; and may be a metal or a nonmetal. Particularly, a metal foil is preferred and examples include an aluminum foil and an aluminum alloy foil. The thickness of the positive electrode lead terminal is preferably 25 to 200 μm and further preferably 50 to 100 μm.

### (Negative Electrode)

The negative electrode includes the negative electrode current collector and the negative electrode active material layer; and the negative electrode active material layer is formed on a part of the negative electrode current collector. Examples of the negative electrode current collector include metal materials, such as a metal film, a metal foil, and a non-woven fabric of metal fibers. The metal foil may be an electrolytic metal foil obtained by an electrolytic method, or a rolled metal foil obtained by a rolling method. An electrolytic method is excellent in mass productivity and has the advantage of production costs being relatively low; whereas a rolling method enables ease in thinning and is advantageous in terms of weight reduction. Among the above, a rolled metal foil is preferred in terms of having crystalline orientation along the rolled direction, and thus, excellent bending resistance.

Examples of the kind of metal used for the negative electrode current collector include copper, copper alloys, nickel, and magnesium alloys. These metals may be used singly or in a combination of two or more. The thickness of the negative electrode current collector 10 is preferably 5 to 30 μm and further preferably 8 to 15 μm.

The negative electrode active material layer may be a material mixture layer including a negative electrode active material and as necessary, a binder and/or a conductive agent. The negative electrode active material is not particularly limited, and can be arbitrarily selected from known materials and compositions. Examples include lithium metal, lithium alloy, a carbon material (e.g., natural graphite, artificial graphite), a silicide (silicon alloy), a silicon oxide, and a lithium-containing titanium compound (e.g., lithium titanate). Among these, lithium metal and lithium alloy are preferred in terms of being able to realize a thin battery with high capacity and high energy density. Examples of the lithium alloy include Li—Si alloy, Li—Sn alloy, Li—Al alloy, Li—Ga alloy, Li—Mg alloy, and Li—In alloy. In view of negative electrode capacity, the proportion of the element other than Li that is present in the lithium alloy is preferably 0.1 to 10 mass %. Examples of the binder and the conductive agent are the same as the materials listed for the positive electrode. Moreover, the amounts of the binder and the conductive agent added are similar to those for the positive electrode.

The thickness of the negative electrode active material layer is, for example, preferably 1 to 300 μm. When the thickness thereof is 1 μm or more, sufficient capacity can be maintained; whereas when the thickness thereof is 300 μm or less, the flexibility of the negative electrode increases and the bending load to the current collector tends to be easily reduced.

### (Negative Electrode Lead Terminal)

The material for the negative electrode lead terminal is not particularly limited if electrochemically and chemically stable and with conductivity; and may be a metal or a nonmetal. Particularly, a metal foil is preferred and examples include a copper foil, a copper alloy foil, and a nickel foil. The thickness of the negative electrode lead terminal is preferably 25 to 200 μm and further preferably 50 to 100 μm.

### (Electrolyte Layer)

The electrolyte layer is not particularly limited. Examples include: a dry polymer electrolyte comprising a polymer matrix and an electrolyte salt contained therein; a gel polymer electrolyte comprising a polymer matrix, and a solvent and an electrolyte salt contained therein via impregnation; an inorganic solid electrolyte; and a liquid electrolyte (electrolyte solution) comprising a solvent and an electrolyte salt dissolved therein.

The material (matrix polymer) used for the polymer matrix is not particularly limited, and can be, for example, a material that gelates by absorbing a liquid electrolyte. Specific examples include a fluorocarbon resin having vinylidene fluoride units, an acrylic resin having (meth)acrylic acid and/or (meth)acrylic acid ester units, and a polyether resin having polyalkylene oxide units. Examples of the fluorocarbon resin having vinylidene fluoride units include polyvinylidene fluoride (PVdF), a copolymer (VdF-HFP) having vinylidene fluoride (VdF) units and hexafluoropropylene (HFP) units, and a copolymer having vinylidene fluoride (VdF) units and trifluoroethylene (TFE) units. In the fluorocarbon resin having vinylidene fluoride units, the amount of the vinylidene fluoride units is preferably 1 mol % or more so that the fluorocarbon resin can easily swell with a liquid electrolyte.

Examples of the electrolyte salt include LiPF₆, LiClO₄, LiBF₄, LiCF₃SO₃, LiCF₃CO₂, and imide salts. Examples of the solvent include non-aqueous solvents, such as: cyclic carbonic acid esters, e.g., propylene carbonate (PC), ethylene carbonate, and butylene carbonate; chain carbonic acid esters, e.g., diethyl carbonate, ethyl methyl carbonate, and dimethyl carbonate (DMC); cyclic carboxylic acid esters, e.g., γ-butyrolactone and γ-valerolactone; and dimethoxyethane (DME). The inorganic solid electrolyte is not particularly limited, and an inorganic material having ion conductivity can be used.

### (Separator)

To prevent a short circuit, a separator may be included in the electrolyte layer. The material for the separator is not particularly limited, and examples include porous sheets having a predetermined ion permeability, mechanical strength, and insulation properties. For example, a porous film or non-woven fabric comprising: a polyolefin, such as polyethylene or polypropylene; a polyamide, such as polyamide or polyamide-imide; cellulose; or the like, is preferable. The thickness of the separator is, for example, 8 to 30 μm.

### (Outer Packaging)

The outer packaging is not particularly limited, and is preferably formed of a film material with low gas permeability and high flexibility. Specific examples include a laminate film comprising a barrier layer and a resin layer formed on one or both surfaces of the barrier layer. In view of strength, gas barrier properties, and bending rigidity, the barrier layer preferably comprises: a metal material, such as aluminum, nickel, stainless steel, titanium, iron, platinum, gold, or silver; or an inorganic material (ceramic material), such as silicon oxide, magnesium oxide, or aluminum oxide. In view of factors similar to the above, the thickness of the barrier layer is preferably 5 to 50 μm.

The resin layer may be a stack of two or more layers. In view of ease in heat sealing, electrolyte resistance, and chemical resistance, the material for the resin layer (sealing layer) disposed on the inner surface side of the outer packaging is preferably a polyolefin such as polyethylene (PE) or polypropylene (PP), polyethylene terephthalate, a polyamide, a polyurethane, a polyethylene-vinyl acetate copolymer (EVA), or the like. The thickness of the resin layer (sealing layer) on the inner surface side is preferably 10 to 100 μm. In view of strength, impact resistance, and chemical resistance, the resin layer (protective layer) disposed on the outer surface side of the outer packaging is preferably a polyamide (PA) such as 6,6-nylon, a polyolefin, a polyester such as polyethylene terephthalate (PET) or polybutylene terephthalate, or the like. The thickness of the resin layer (protective layer) on the outer surface side is preferably 5 to 100 μm.

Specific examples of the outer packaging include: a laminate film comprising PE/Al layer/PE; a laminate film comprising acid-modified PP/PET/Al layer/PET; a laminate film comprising acid-modified PE/PA/Al layer/PET; a laminate film comprising ionomer resin/Ni layer/PE/PET; a laminate film comprising ethylene-vinyl acetate/PE/Al layer/PET; and a laminate film comprising ionomer resin/PET/Al layer/PET. Here, instead of an Al layer, an inorganic compound layer such as an Al₂O₃ layer or a SiO₂ layer may be used.

The thin battery of the present invention can be produced in the following manner.

### (Production of Positive Electrode)

A positive electrode active material, a conductive agent, and a binder are mixed to prepare a positive electrode material mixture; and then, the positive electrode material mixture is dispersed in a solvent such as N-methyl-2-pyrrolidone (NMP) to prepare a positive electrode material mixture slurry. Then, the positive electrode material mixture slurry is applied partially to one or both surfaces of a positive electrode current collector. After the solvent is dried, by compression forming with a roll press machine or the like, the positive electrode current collector is provided with a formed portion on which a positive electrode active material layer is formed, and a non-formed portion. Furthermore, a part of the non-formed portion is cut to provide an extending portion that extends from a part of one side of the non-formed portion, thereby to produce a positive electrode.

Alternatively, the above positive electrode material mixture may be applied entirely to one or both surfaces of the positive electrode current collector, and after drying and compression forming, the resultant may be cut to a predetermined shape including the extending portion. Then, the portions of the positive electrode active material layer corresponding to the extending portion and the non-formed portion may be peeled, thereby to produce a positive electrode.

### (Joining of Positive Electrode Lead Terminal)

A positive electrode lead terminal is joined to the positive electrode produced. The positive electrode lead terminal is placed astride the non-formed portion and the extending portion, such that an endmost portion thereof is positioned on the non-formed portion and joined to the positive electrode current collector by a welding method, such as ultrasonic welding. At that time, most of a first end portion of the positive electrode lead terminal, e.g., 90% or more of the area thereof overlapping the positive electrode current collector, may be joined to the positive electrode current collector.

### (Production of Negative Electrode)

A negative electrode active material, a conductive agent, and a binder are mixed to prepare a negative electrode material mixture, and then, the negative electrode material mixture is dispersed in a solvent such as NMP to prepare a negative electrode material mixture slurry. Then, the negative electrode material mixture slurry is applied partially to one or both surfaces of the negative electrode current collector. After the solvent is dried, by compression forming with a roll press machine or the like, the negative electrode current collector is provided with a formed portion on which a negative electrode active material layer is formed, and a non-formed portion. Furthermore, a part of the non-formed portion is cut to provide an extending portion extending from a part of one side of the non-formed portion, thereby to produce a negative electrode.

Alternatively, the above negative electrode material mixture may be applied entirely to one or both surfaces of the negative electrode current collector, and after drying and compression forming, the resultant may be cut to a predetermined shape including the extending portion. Then, the portions of the negative electrode active material layer corresponding to the extending portion and the non-formed portion may be peeled, thereby to produce a negative electrode. When the negative electrode active material layer is to comprise lithium metal and/or lithium alloy, a foil thereof can be cut to a predetermined shape corresponding to the formed portion and then pressure bonded to the negative electrode current collector also cut to a predetermined shape, thereby to produce a negative electrode.

### (Joining of Negative Electrode Lead Terminal)

A negative electrode lead terminal is joined to the negative electrode produced. The negative electrode lead terminal is placed astride the non-formed portion and the extending portion, such that an endmost portion thereof is positioned on the non-formed portion and joined to the negative electrode current collector by a welding method. At that time, most of a first end portion of the negative electrode lead terminal, e.g., 90% or more of the area thereof overlapping the negative electrode current collector, may be joined to the negative electrode current collector.

### (Production of Electrolyte Layer)

An electrolyte layer can be produced by a method in which powder of an inorganic solid electrolyte is mixed with a binder, and the mixture is applied to a film and then peeled therefrom; a method in which a deposited film of an inorganic solid electrolyte is formed on a film and then peeled therefrom; a method in which a separator is impregnated with a polymer matrix, a solvent, and an electrolyte salt; a method in which a separator is impregnated with a solvent and an electrolyte salt (electrolyte solution); or the like. Impregnation of the separator with the solvent and the electrolyte salt may be conducted after the electrode assembly is inserted in the outer packaging.

### (Production of Electrode Assembly)

The positive electrode and the negative electrode produced are overlapped, with the electrolyte layer interposed therebetween, thereby to produce an electrode assembly. At that time, as illustrated in FIG. 1D, the positive electrode active material layer 8 and the negative electrode active material layer 11 are disposed to face each other, with the electrolyte layer 12 interposed therebetween. Note that the extending portion of the positive electrode and the extending portion of the negative electrode are preferably formed to not overlap each other, and furthermore, to have a certain amount of distance maintained therebetween, when the positive electrode and the negative electrode are stacked. This is done so that a short circuit would not easily occur.

### (Sealing)

The electrode assembly is placed in the outer packaging, such that respective second end portions of the positive electrode lead terminal and the negative electrode lead terminal extend out of the outer packaging. Then, for sealing, a predetermined portion of the outer packaging is heat sealed with a hot plate or the like under reduced pressure. At that time, after the outer packaging is heat sealed with a hot plate or the like and with one side thereof left unsealed, an electrolyte solution (solvent and/or electrolyte salt) may be injected into the resultant pouch-like outer packaging from an opening portion thereof; and thereafter, the remaining unsealed side thereof may be sealed under reduced pressure. By the above, a thin battery is produced.

### EXAMPLES

Examples of the present invention will now be specifically described. However, the following Examples are not to be construed as limiting in any way the scope of the present invention.

### Example 1

By the following procedures, a thin battery having a structure of <negative electrode/positive electrode/negative electrode> was produced.

### (1) Production of Positive Electrode

Electrolytic manganese dioxide (positive electrode active material) having undergone heat treatment at 350° C., acetylene black (conductive agent), and polyvinylidene fluoride (PVdF, binder) were mixed in NMP, such that the mass ratio of manganese dioxide:acetylene black:PVdF became 100:6:5. Thereafter, a moderate amount of NMP was further added to the mixture to adjust viscosity, thereby to obtain a positive electrode material mixture in paste form.

The positive electrode material mixture in paste form was applied to both surfaces of an aluminum foil (positive electrode current collector 7). This was dried at 85° C. for 10 minutes and thereafter compressed under a linear pressure of 12000 N/cm with a roll press machine, thereby to form a positive electrode active material layer 8 (thickness: 90 μm) on both surfaces of the positive electrode current collector 7. The positive electrode current collector 7 with the positive electrode active material layer 8 formed on both surfaces thereof was cut to a shape having a rectangular main portion (length: 54.5 mm, width: 22.0 mm) and an extending portion (length: 6 mm, width: 6 mm) extending from one side of the main portion 22.0 mm long, followed by drying under reduced pressure at 120° C. for 2 hours. Thereafter, the positive electrode active material layer formed entirely on both surfaces of the extending portion and formed on both surfaces of a substantially rectangular region (width A1: 2.0 mm, length: 22.0 mm) including the side of the main portion from which the extending portion extended, was peeled. As such, as in FIG. 4, a formed portion 7b, a substantially rectangular non-formed portion 7c, and an extending portion 7a were formed on the positive electrode current collector 7. Note that a thickness D1 of the positive electrode current collector 7 was 15 μm.

Subsequently, on one surface of the positive electrode, a positive electrode lead terminal 4 (width: 3 mm, thickness C1: 50 μm) made of aluminum was disposed astride the non-formed portion 7c and the extending portion 7a, and the overlapped portion was entirely subjected to ultrasonic welding. Here, the positive electrode lead terminal 4 was disposed such that a minimal length B1 from an endmost portion 4e thereof to the formed portion 7c was 1 mm.

### (2) Production of Negative Electrode

A copper foil (negative electrode current collector 10) was cut to two pieces each having a shape with a rectangular main portion (length: 56.5 mm, width: 24.0 mm) and an extending portion 10a (length: 5 mm, width: 6 mm) extending from one side of the main portion 24.0 mm long. To one surface of each of the cut pieces obtained, a lithium metal foil (negative electrode active material layer 11, thickness: 35 μm) was pressure bonded under a linear pressure of 100 N/cm. At that time, a substantially rectangular region (width A2: 2.0 mm, length: 24.0 mm) including the side of the main portion from which the extending portion 10a extended, was referred to as a non-formed portion 10c; and the lithium metal foil was pressure bonded to a region other than the extending portion 10a and the non-formed portion 10c. As such, two negative electrodes 9 each having the negative electrode active material layer 11 on one surface, were produced.

For one of the negative electrodes produced, on the surface without the negative electrode active material layer 11 formed thereon, a negative electrode lead terminals (width: 1.5 mm, thickness C2: 50 μm) made of copper was placed astride the non-formed portion 10c and the extending portion 10a; and the overlapped portion was entirely subjected to ultrasonic welding. Here, the negative electrode lead terminal 5 was disposed such that a minimal length B2 from an endmost portion 5e thereof to the formed portion 10c was 1 mm. A thickness D2 of the negative electrode current collector 10 was 15 μm.

### (3) Production of Electrolyte Layer

LiClO₄ (electrolyte salt) was dissolved in a non-aqueous solvent obtained by mixing PC and DME in a proportion of 6:4 (mass ratio), such that the concentration of the LiClO₄ became 1 mol/kg, thereby to prepare a liquid electrolyte.

By using a copolymer of HFP and VdF (HFP content: 7 mol %) as a matrix polymer, the matrix polymer and the liquid electrolyte were mixed in a proportion of 1:10 (mass ratio). Then, by using DMC as a solvent, a solution of a gel polymer electrolyte was prepared.

The gel polymer electrolyte solution obtained was uniformly applied to both surfaces of a 9 μm-thick separator made of porous polyethylene, followed by vaporization of the solvent, thereby to produce an electrolyte layer 12 (width: 27.0 mm, length: 59.5 mm) comprising the separator impregnated with the gel polymer electrolyte.

### (4) Production of Electrode Assembly

The positive electrode 6 and the two negative electrodes 9 produced were stacked as illustrated in FIG. 4, such that the positive electrode active material layers 8 and the negative electrode active material layers 11 faced one another, respectively. The respective extending portions 10a of the two negative electrodes 9 were electrically joined by ultrasonic welding. Thereafter, hot pressing was conducted at 90° C. and 1.0 MPa for 30 seconds, thereby to produce an electrode assembly 2 (thickness: 325 μm).

A film material (PE protective layer/Al layer/PE sealing layer) was prepared, the film material comprising: an aluminum foil (thickness: 15 μm) as a barrier layer; a PE film (thickness: 50 μm) as a sealing layer, disposed on one surface of the barrier layer; and a PE film (thickness: 50 μm) as a protective layer, disposed on the other surface of the barrier layer. After the film material was formed into a pouch-like outer packaging 3 of 35.0 mm×70.0 mm, the electrode assembly 2 was inserted therein, such that respective second end portions (4b and 5b) of the positive electrode lead terminal and the negative electrode lead terminal were exposed to the outside from an opening portion of the outer packaging 3. The outer packaging 3 with the electrode assembly 2 inserted therein was placed in an atmosphere with pressure adjusted to 660 mmHg, and the opening portion was heat sealed in this atmosphere. Thus, a thin battery with a size of 35.0 mm×70.0 mm was produced. Note that the respective extending portions of the positive electrode and the negative electrode did not overlap the sealed portion (heat sealed portion).

### Example 2

The positive electrode lead terminal 4 and the negative electrode lead terminal 5 were disposed, such that the minimal length B1 from the endmost portion 4e of the lead terminal 4 to the formed portion 7c and the minimal length B2 from the endmost portion 5e of the lead terminal 5 to the formed portion 10c were both 1.5 mm. Except for the above, a thin battery was produced as in Example 1.

### Example 3

The positive electrode lead terminal 4 and the negative electrode lead terminal 5 were disposed, such that the minimal length B1 from the endmost portion 4e of the lead terminal 4 to the formed portion 7c and the minimal length B2 from the endmost portion 5e of the lead terminal 5 to the formed portion 10c were both 1.6 mm. Except for the above, a thin battery was produced as in Example 1.

### Example 4

The positive electrode lead terminal 4 and the negative electrode lead terminal 5 were disposed, such that the minimal length B1 from the endmost portion 4e of the lead terminal 4 to the formed portion 7c and the minimal length B2 from the endmost portion 5e of the lead terminal 5 to the formed portion 10c were both 0.5 mm. Except for the above, a thin battery was produced as in Example 1.

### Example 5

The positive electrode lead terminal 4 and the negative electrode lead terminal 5 were disposed, such that the minimal length B1 from the endmost portion 4e of the lead terminal 4 to the formed portion 7c and the minimal length B2 from the endmost portion 5e of the lead terminal 5 to the formed portion 10c were both 0.4 mm. Except for the above, a thin battery was produced as in Example 1.

### Example 6

The thickness C1 of the positive electrode lead terminal 4 and the thickness C2 of the negative electrode lead terminal 5 were both made 100 μm. Except for the above, a thin battery was produced as in Example 1. Note that the thickness of the electrode assembly 2 was 325 μm.

### Example 7

The thickness D1 of the positive electrode current collector 7 and the thickness D2 of the negative electrode current collector 10 were both made 8 μm. Except for the above, a thin battery was produced as in Example 1. Note that the thickness of the electrode assembly 2 was 311 μm.

### Example 8

As illustrated in FIG. 1D, the positive electrode 6 in which the positive electrode active material layer 8 was formed on only one surface of the positive electrode current collector 7, and one of the negative electrodes 9, were stacked with the electrolyte layer 12 interposed therebetween, such that the positive electrode active material layer 8 and the negative electrode active material layer 11 faced each other. Except for the above, a thin battery having a structure of negative electrode/positive electrode was produced as in Example 1. Note that the thickness of the electrode assembly 2 was 170 μm.

### Comparative Example 1

As illustrated in FIG. 6B, a positive electrode 102 in which a positive electrode active material layer 105 was formed entirely on one surface of a positive electrode current collector 104 excluding an extending portion 104a, was produced. A positive electrode lead terminal 106 was welded onto the extending portion 104a on the side of the positive electrode current collector 104 with the positive electrode active material layer formed thereon. Separately, a negative electrode 103 in which a negative electrode active material layer 108 was formed entirely on one surface of a negative electrode current collector 107 excluding an extending portion 107a, was produced. A negative electrode lead terminal 109 was welded onto the extending portion 107a on the side of the negative electrode current collector 107 with the negative electrode active material layer formed thereon. At that time, the positive electrode lead terminal 106 was disposed, such that there was no contact between an endmost portion 106e thereof and the positive electrode active material layer 105; and the negative electrode lead terminal 109 was disposed, such that there was no contact between an endmost portion 109e thereof and the negative electrode active material layer 108. Except for the above, a thin battery was produced as in Example 8.

### Comparative Example 2

The positive electrode lead terminal 4 and the negative electrode lead terminal 5 were disposed, such that the minimal length B1 from the endmost portion 4e of the lead terminal 4 to the formed portion 7c and the minimal length B2 from the endmost portion 5e of the lead terminal 5 to the formed portion 10c were both 4.0 mm, that is, such that the endmost portion 4e and the endmost portion 5e were not positioned on the respective non-formed portions. Except for the above, a thin battery was produced as in Example 1.

### Comparative Example 3

The positive electrode and the negative electrode were produced, such that the respective extending portions were 20 mm; the positive electrode lead terminal 4 and the negative electrode lead terminal 5 were not joined; and the opening portion of the outer packaging 3 was heat sealed, with the above extending portions partially extended to the outside. Except for the above, a thin battery was produced as in Example 1.

### [Initial Discharge Capacity]

The thin batteries produced were each discharged in a 25° C. environment, under conditions of a discharge current density of 250 hA/cm² and an end-of-discharge voltage of 1.8 V, thereby to obtain their respective initial discharge capacities.

### [Bending Test]

The thin batteries produced were each subjected to the following bending test.

FIG. 5 is an explanatory illustration to explain the method of the bending test.

First, one side of the thin battery 1 from which the electrode lead terminals were extended to the outside, and one side opposing that side, were fixed with a pair of fixtures. Then, a jig 13 for the bending test having a front end surface with a radius of curvature r of 30 mm was pressed against the fixed thin battery 1. At that time, the jig 13 was pressed until the radius of curvature of the thin battery 1 uniformly became 30 mm as the radius of curvature r of the jig 13. Then, the jig 13 was separated from the thin battery 1, which was left to recover from the deformation until becoming flat again as before. The above bending deformation and recovery therefrom as 1 set, were repeated 10,000 times. Note that the time for 1 bending deformation was about 30 seconds, and the time for 1 recovery therefrom was about 30 seconds. For the bending test, 10 batteries were used per Example and per Comparative Example.

### [Evaluation for Bending Resistance Performance]

### (1) Discharge Capacity Retention Rate

On the thin batteries after the bending test, their respective discharge capacities were measured under the same conditions as above, and their respective discharge capacity retention rates were obtained by a calculation formula of (discharge capacity after bending test/discharge capacity before bending test)×100 (%). Their respective discharge capacity retention rates were calculated as an average obtained for 10 batteries.

### (2) Current Collector Damage Rate

The thin batteries after the bending test were each disassembled and checked for any damages (breaks, cuts) to the current collectors. Their respective current collector damage rates were obtained by a calculation formula of (number of batteries with damage to current collectors/10 batteries)×100 (%). The results are all shown together in Table 1.

TABLE 1

| | | | | | | | | Capacity | |
|---|---|---|---|---|---|---|---|---|---|
| | Structure of | A1 | B1 | | C1 | D1 | | retention | Damage |
| | electrode | (A2) | (B2) | B1/A1 | (C2) | (D2) | C1/D1 | rate | rate |
| | assembly | [mm] | [mm] | B2/A2 | [μm] | [μm] | C2/D2 | (%) | (%) |
| Ex. 1 | FIG. 4 | 2 | 1 | 0.5 | 50 | 15 | 3.33 | 98 | 0 |
| Ex. 2 | FIG. 4 | 2 | 1.5 | 0.75 | 50 | 15 | 3.33 | 97 | 0 |
| Ex. 3 | FIG. 4 | 2 | 1.6 | 0.8 | 50 | 15 | 3.33 | 92 | 0 |
| Ex. 4 | FIG. 4 | 2 | 0.5 | 0.25 | 50 | 15 | 3.33 | 97 | 0 |
| Ex. 5 | FIG. 4 | 2 | 0.4 | 0.2 | 50 | 15 | 3.33 | 92 | 0 |
| Ex. 6 | FIG. 4 | 2 | 1 | 0.5 | 100 | 15 | 6.67 | 92 | 0 |
| Ex. 7 | FIG. 4 | 2 | 1 | 0.5 | 50 | 8 | 6.25 | 96 | 0 |
| Ex. 8 | FIG. 1D | 2 | 1 | 0.5 | 50 | 15 | 3.33 | 92 | 0 |
| Comp. | FIG. 6 | 0 | — | — | 50 | 15 | 3.33 | 48 | 40 |
| Ex. 1 | | | | | | | | | |
| Comp. | — | 2 | 4 | 2.0 | 50 | 15 | 3.33 | 63 | 30 |
| Ex. 2 | | | | | | | | | |
| Comp. | — | 2 | — | — | — | 15 | — | 60 | 30 |
| Ex. 3 | | | | | | | | | |

As shown in Table 1, the thin batteries produced in Examples 1 to 8 exhibited good discharge characteristics after the bending test, and breaks and cracks were not observed in the current collectors. However, the thin batteries produced in Comparative Examples 1 and 2 exhibited very low discharge characteristics after the bending test. As a result of disassembling these batteries, cracks and breaks were observed in the current collectors after the bending test, at positions corresponding to the endmost portions of the electrode lead terminals. This was presumably because wrinkles and load caused by bending concentrated on the positions on the current collectors corresponding to the endmost portions, when the batteries were subjected to bending deformation.

Moreover, in Comparative Example 3 in which the electrode lead terminals were not used and the extending portions were extended to the outside to be used instead as the electrode lead terminals, there were observed batteries with cuts in such extending portions, in the vicinity of the sealing portion of the outer packaging. Presumably, at the time of heat sealing the outer packaging for battery production, the thin low-strength current collectors were damaged at the sealing portion due to the heat sealing pressure; and thereafter, such damaging progressed by repeated bending deformation and ultimately led to occurrence of cuts. Since the batteries with cuts in the extending portions could not undergo the discharge test after the bending test, their respective capacity retention rates were regarded as 0%. For the respective capacity retention rates in Table 1, an average obtained for a total of 10 batteries including the above batteries, are shown.

Among the batteries in Example 3, there was one in which the behavior of the discharge voltage after the bending test was unstable and the discharge voltage lowered to the end-of-discharge voltage before reaching the theoretical capacity, thereby causing the resultant discharge capacity to be small. As a result of disassembling this battery, cracks in very small amounts were observed in the current collectors around where the endmost portions of the electrode lead terminals were positioned. B1/A1 and B2/A2 in Example 3 were both 0.8. As such, evidently, when the respective joining areas between the electrode lead terminals and the non-formed portions were small, the joining strength became insufficient, and there were instances where cracks occurred in the current collectors due to bending deformation. Thus, B/A≦0.75 is preferable.

Among the batteries in Example 5 also, there was one in which the behavior of the discharge voltage after the bending test was unstable, resulting in a small discharge capacity. As a result of disassembling this battery, cracks in very small amounts were observed in the current collectors around where the endmost portions of the electrode lead terminals were positioned. B1/A1 and B2/A2 in Example 5 were both 0.2. As such, evidently, when the respective regions of the non-formed portions between the first end portions of the electrode lead terminals and the formed portions were small, the bending load concentrated on relatively narrow regions, and therefore, there were instances where cracks occurred in the current collectors due to bending deformation. Thus, 0.25≦B/A is preferable.

Among the batteries in Example 6 also, there was one in which the behavior of the discharge voltage after the bending test was unstable, resulting in a small discharge capacity. As a result of disassembling this battery, cracks in very small amounts were observed in the current collectors around where the endmost portions of the electrode lead terminals were positioned. C1/D1 and C2/D2 in Example 6 were both 6.67. As such, when the respective thicknesses of the electrode lead terminals were excessively greater than the respective thicknesses of the current collectors, since there were greater differences in rigidity between the electrode lead terminals and the current collectors, there were instances where a greater load occurred in the vicinity of the endmost portions of the electrode lead terminals and cracks occurred in the current collectors.

Moreover, the capacity retention rate in Example 7 was good. From such results, C/D≦6.25 is preferable.

Among the batteries in Example 8 also, there was one in which the behavior of the discharge voltage after the bending test was unstable, resulting in a small discharge capacity. As a result of disassembling this battery, cracks in very small amounts were observed in the current collectors around where the endmost portions of the electrode lead terminals were positioned. In Example 8, one positive electrode and one negative electrode were stacked. From this fact, when two or more electrodes were stacked for either one of the positive electrode or the negative electrode as in Example 1, presumably, there was an increase in the respective apparent thicknesses of the current collectors at positions corresponding to the endmost portions of the electrode lead terminals, and there was a reduction in the bending load. Thus, for at least one of the positive electrode and the negative electrode, two or more electrodes are preferably stacked.

### Example 9

By the following procedures, a thin battery having a structure of <negative electrode/positive electrode/negative electrode/positive electrode/negative electrode/positive electrode/negative electrode/positive electrode/negative electrode> was produced.

### (1) Production of Positive Electrode

LiCoO₂ (positive electrode active material) having an average particle size of 20 μm, acetylene black (conductive agent), and PVdF (binder) were mixed in NMP, such that the mass ratio of LiCoO₂:acetylene black:PVdF became 100:2:2. Thereafter, a moderate amount of NMP was further added to the mixture to adjust viscosity, thereby to obtain a positive electrode material mixture in paste form. Except for using this positive electrode material mixture to form a positive electrode active material layer on both surfaces of the positive electrode current collector 7, four positive electrodes 6 were produced as in Example 1, each including the positive electrode current collector 7 having a formed portion 7b, a substantially rectangular non-formed portion 7c, and an extending portion 7a.

Then, as in Example 1, a positive electrode lead terminal 4 was welded to one among the four positive electrodes obtained. The thickness D1 of the positive electrode current collector 7 to which the positive electrode lead terminal 4 was welded, was 15 μm. Moreover, as in Example 1, the width A1 was 2 mm and the minimal length B1 was 1 mm.

### (2) Production of Negative Electrode

Hundred parts by mass of graphite (negative electrode active material) having an average particle size of 22 μm, 8 parts by mass of a VdF-HFP copolymer (content of VdF units: 5 mol %, binder), and a moderate amount of NMP were mixed, thereby to obtain a negative electrode material mixture in paste form.

The negative electrode material mixture in paste form was applied to both surfaces of a copper foil (negative electrode current collector 10). Another copper foil (negative electrode current collector 10) with the negative electrode material mixture in paste form applied to one surface thereof, was prepared separately. These were dried at 85° C. for 10 minutes and thereafter compressed under a linear pressure of 12000 N/cm with a roll press machine. From the negative electrode current collector 10 with the negative electrode active material layer 8 formed on both surfaces thereof, three negative electrodes each having a shape similar to the one in Example 1, were cut out. Furthermore, for each of these three negative electrodes, the negative electrode active material layers on both surfaces of the negative electrode current collector 10 were partially peeled, thereby to produce three negative electrodes as in Example 1, each having a formed portion 10b, a substantially rectangular non-formed portion 10c, and an extending portion 10a on both surfaces of the negative electrode current collector 10.

From the separately-prepared negative electrode current collector 10 with the negative electrode active material layer 8 formed on one surface thereof, two negative electrodes each having a shape similar to the one in Example 1, were cut out. Furthermore, for each of these two negative electrodes, the negative electrode active material layer on one surface of the negative electrode current collector 10 was partially peeled, thereby to produce two negative electrodes as in Example 1, each having a formed portion 10b, a substantially rectangular non-formed portion 10c, and an extending portion 10a on one surface of the negative electrode current collector 10.

Subsequently, as in Example 1, a negative electrode lead terminal 5 was welded to one among the negative electrodes obtained, that is, the one with the negative electrode active material layer formed on one surface of the negative electrode current collector 10. For the negative electrode lead terminal 5, a nickel foil (width: 3 mm, thickness C2: 50 μm) was used. The thickness D2 of the negative electrode current collector 10 to which the negative electrode lead terminal 5 was welded, was 8 μm. Moreover, as in Example 1, the width A2 was 2 mm and the minimal length B2 was 1 mm.

The above four positive electrodes 6 each with the positive electrode active material layer formed at both surfaces thereof, and the above three negative electrodes 9 each with the negative electrode active material layer formed at both surfaces thereof, were disposed, such that the positive electrode active material layers 8 and the negative electrode active material layers 11 faced one another, respectively, with an electrolyte layer 12 interposed therebetween. Note that the positive electrode 6 with the positive electrode lead terminal joined thereto, was disposed as one of the outermost electrodes of this stack. Then, on the outer side of this positive electrode 6 with the positive electrode lead terminal joined thereto, the negative electrode 9 with the negative electrode active material layer formed at one surface thereof and without the negative electrode lead terminal, was disposed. On the outer side of the positive electrode 6 without the positive electrode lead terminal and disposed as the other outermost electrode of the stack, the negative electrode 9 with the negative electrode active material layer formed at one surface thereof and with the negative electrode lead terminal joined thereto, was disposed. The respective extending portions 10a of the five negative electrodes in total, were electrically joined together by ultrasonic welding. Likewise, the respective extending portions 7a of the four positive electrodes 6 were electrically joined together by ultrasonic welding. Thereafter, hot pressing was conducted at 90° C. and 1.0 MPa for 30 seconds, thereby to produce an electrode assembly 2 (thickness: 1475 μm). The electrode assembly 2 obtained was sealed inside an outer packaging as in Example 1, thereby to produce a thin battery 1.

### Comparative Example 4

The non-formed portion was not provided in the positive electrode; and the positive electrode lead terminal was welded onto the extending portion, such that there was no contact between the first end portion of the positive electrode lead terminal and the positive electrode active material layer. Moreover, the non-formed portion was not provided in the negative electrode; and the negative electrode lead terminal was welded onto the extending portion, such that there was no contact between the first end portion of the negative electrode lead terminal and the negative electrode active material layer. Except for the above, a thin battery was produced as in Example 9.

### [Initial Discharge Capacity]

The thin batteries produced were each subjected to the following charge and discharge in an environment at 25° C., thereby to obtain their respective initial capacities. Note that the respective design capacities of the thin batteries were 1 C (mAh).

(1) Constant current charge: 0.7 CmA (end-of-charge voltage: 4.2 V)

(2) Constant voltage charge: 4.2 V (end-of-charge current: 0.05 CmA)

(3) Constant current discharge: 0.2 CmA (end-of-discharge voltage: 3 V)

### [Evaluation for Bending Resistance Performance]

### (1) Discharge Capacity Retention Rate

After conducting the bending test as for Example 1, discharge capacities were measured under the same conditions as above, and discharge capacity retention rates were obtained by a calculation formula of (discharge capacity after bending test/discharge capacity before bending test)×100 (%). The respective discharge capacity retention rates were calculated as an average obtained for 10 batteries. The discharge capacity retention rate for Example 9 was 98% and that for Comparative Example 4 was 61%.

### (2) Current Collector Damage Rate

The thin batteries after the bending test were each disassembled after discharge and checked for any damages (breaks, cuts) to the current collectors. The respective current collector damage rates were obtained by a calculation formula of (number of batteries with damage to current collectors/10 batteries)×100 (%). The current collector damage rate for Example 9 was 0% and that for Comparative Example 4 was 30%.

As evidenced by the above, bending resistance of the thin battery improves by joining the electrode lead terminals to the corresponding current collectors, such that each one of the terminals extend astride the non-formed portion and the extending portion; and also, by positioning each one of the endmost portions of the electrode lead terminals on the non-formed portion.

### INDUSTRIAL APPLICABILITY

The thin battery of the present invention can be installed, not only in electronic papers, IC tags, multifunctional cards, and electronic keys, but also in various electronic devices, such as biometric information measurement devices and iontophoretic transdermal drug administration devices. Particularly, the thin battery of the present invention is useful for installment in electronic devices having flexibility, specifically, electronic devices whose battery needs to have a high bending resistance performance.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### EXPLANATION OF REFERENCE NUMERALS

1 thin battery
2 electrode assembly
3 outer packaging
4 positive electrode lead terminal
4a first end portion
4b second end portion
4e endmost portion
5 negative electrode lead terminal
5a first end portion
5b second end portion
5e endmost portion
6 positive electrode
7 positive electrode current collector
7a extending portion
7b formed portion
7c non-formed portion
8 positive electrode active material layer
9 negative electrode
10 negative electrode current collector
10a extending portion
10b formed portion
10c non-formed portion
11 negative electrode active material layer
12 electrolyte layer
13 jig
20 electrode assembly
60 positive electrode
100 current collector
100a extending portion
100b formed portion
100c non-formed portion
101 thin battery
102 positive electrode
103 negative electrode
104 positive electrode current collector
105 positive electrode active material layer
106 positive electrode lead terminal
106e endmost portion
107 negative electrode current collector
108 negative electrode active material layer
109 negative electrode lead terminal
F109e endmost portion
110 electrolyte layer
111 electrode assembly
112 outer packaging
200 electrode lead terminal
200a first end portion
200e endmost portion

1. A thin battery comprising:
an electrode assembly in sheet form including a positive electrode, a negative electrode, and an electrolyte layer interposed between the positive electrode and the negative electrode;
a pair of electrode lead terminals, the terminals connected to the positive electrode and the negative electrode, respectively; and
an outer packaging housing the electrode assembly,
each one of the positive electrode and the negative electrode including a current collector and an active material layer,
the current collector having a main portion and an extending portion extending from a part of the main portion,
the main portion having a formed portion on which the active material layer is formed and a non-formed portion on which the active material layer is not formed,
the extending portion extending from a part of the non-formed portion,
a first end portion of each of the electrode lead terminals having a joining portion joined to the non-formed portion and the extending portion, and
a second end portion of each of the electrode lead terminals extended out of the outer packaging.

2. The thin battery in accordance with claim 1, wherein the first end portion and the formed portion are not in contact with each other.

3. The thin battery in accordance with claim 1, wherein a length B of a minimal-length line L connecting the first end portion and the formed portion and a maximum width A of the non-formed portion parallel to the minimum-length line L satisfy a relation of 0.25≦B/A≦0.75.

4. The thin battery in accordance with claim 1, wherein a ratio between a thickness C of the electrode lead terminal and a thickness D of the current collector to which the electrode lead terminal is joined: C/D, is 6.25 or less.

5. The thin battery in accordance with claim 1, wherein for at least one of the positive electrode and the negative electrode, two or more electrodes are stacked.

6. The thin battery in accordance with claim 2, wherein for at least one of the positive electrode and the negative electrode, two or more electrodes are stacked.

7. The thin battery in accordance with claim 3, wherein for at least one of the positive electrode and the negative electrode, two or more electrodes are stacked.

8. The thin battery in accordance with claim 4, wherein for at least one of the positive electrode and the negative electrode, two or more electrodes are stacked.
